(19) United States
(12) Patent Application Publication
(10) Pub. No.: US 2025/0256410 A1
(43) Pub. Date: Aug. 14, 2025

(54) FINGER AND GRIPPING DEVICE FOR ROBOT ARM, AND ROBOT ARM EQUIPPED WITH SUCH A DEVICE

(71) Applicants: FINRIP, MONTELIER (FR); COMMISSARIAT A L`ENERGIE ATOMIQUE ET AUX ENERGIES ALTERNATIVES, PARIS (FR)

(72) Inventors: Michel CECCHIN, MONTELIER (FR); Pierre MILHAU, CHATUZANGE-LE-GOUBET (FR); Mathieu GROSSARD, GIF-SUR-YVETTE (FR)

(21) Appl. No.: 18/707,409

(22) PCT Filed: Nov. 4, 2022
(86) PCT No.: PCT/EP2022/080885

§ 371 Date: May 3, 2024

(30) Foreign Application Priority Data
Nov. 4, 2021 (FR) FR2111734

(51) Int. Cl. B25J 15/08

(52) U.S. Cl. CPC B25J 15/08

(57) ABSTRACT

A motorized finger includes a base for fastening to a plate connecting to a robotic arm, a first phalanx connected to the base by at least one first articulation, a second phalanx connected to the first phalanx by at least one second articulation, and a first actuator fastened to the base and connected at least to the first phalanx in order to move the phalanges between two end positions.

The present invention relates to the field of handling and more specifically, handling by robots, including cobots.

### BACKGROUND OF THE INVENTION

Robot arms (or robotic arms) comprising a base are known, a first segment connected to the base by a first articulation, a second segment connected to the first segment by a second articulation, and a gripping device connected to the second segment by a third articulation commonly called wrist. The gripping device can comprise electromagnetic gripping means, suction cups connected to a suctioning device or articulated fingers connected to one single motor controlling the simultaneous actuation of the fingers.

Generally, the gripping device is made bespoke for the task to be accomplished and the shape of the objects to grip. This results in a lack of flexibility and significant costs, when this relates to adapting said device for gripping the objects to be gripped.

There are also robotic “hands” for universal use, but at the expense of a significant complexity and of a significant cost.

### AIM OF THE INVENTION

The invention in particular aims to provide an at least partial solution to the problems above.

### SUMMARY OF THE INVENTION

To this end, a motorised finger is provided, according to the invention, comprising a base for fastening to a plate for connecting to a robotic arm, a first phalanx connected to the base by at least one first articulation, a second phalanx connected to the first phalanx by at least one second articulation, a first actuator fastened to the base and connected at least to the first phalanx in order to move the phalanxes between two end positions, the base comprising a fixed part and a movable part which carries the first actuator and the phalanxes and which is connected to the fixed part by a bearing defining an orientation axis and enabling a rotation of the movable part with respect to the fixed part about said axis of orientation, the base comprising means for its fastening to the plate, such that the axis of orientation is substantially perpendicular to the plate, the motorised finger further comprising an individual control unit, secured to the base, which is connected to the first actuator to control it.

It is subsequently possible to rapidly produce a hand by assembling one or more fingers and a connecting plate according to the arrangement which is most suitable for the task to be performed and for the objects to be gripped. Each finger being autonomous regarding the motorisation of the phalanxes and controlling this motorisation, the synchronisation of the fingers together, when there are several of them, can be performed by controlling different fingers and not by a mechanical movement synchronisation device, which simplifies the structure of the gripping device thus produced.

For example, the synchronisation can be performed via a general control unit to which the actuators and/or the individual control units are connected.

In this case, it is understood that the first phalanx is connected to the movable part of the base.

Optionally, the individual control unit is secured to the fixed part of the base.

Optionally, the first actuator is an electric and/or hydraulic and/or pneumatic actuator.

Optionally, the first actuator is an at least partially electric actuator (and for example, electric and pneumatic or electric and hydraulic) or is an exclusively electric actuator.

Optionally, the individual control unit is at least partially an individual electronic control unit or is exclusively an individual electronic control unit. Optionally, the general control unit is at least partially a general electronic control unit or is exclusively a general electronic control unit.

Optionally, the motorised finger comprises a second actuator arranged to make the movable part pivot and adjust the angular orientation of the movable part with respect to the fixed part.

Optionally, the individual control unit controlling the first actuator, is also configured to control the second actuator.

Optionally, the second actuator is an electric and/or hydraulic and/or pneumatic actuator.

Optionally, the second actuator is an at least partially electric actuator (and for example, electric and pneumatic, or electric and hydraulic) or is an exclusively electric actuator.

The invention also aims for a gripping device comprising a connecting plate and at least one finger of the abovementioned type.

The invention also aims for a robot arm equipped with such a gripping device.

Other features and advantages of the invention will emerge upon reading the description below of particular and non-limiting embodiments of the invention.

### BRIEF DESCRIPTION OF THE DRAWINGS

Reference will be made to the accompanying drawings, among which:

FIG. 1 is a schematic, side view of a robotic arm according to the invention;

FIG. 2 is a schematic, perspective view of a gripping device according to a first embodiment;

FIG. 3 is a schematic, perspective view of one of the fingers of the device;

FIG. 4 is a schematic, side view of this finger, showing the amplitude of possible movement;

FIG. 5 is a schematic, rear view of this finger;

FIG. 6 is a schematic, side view of the device showing a mode of powerfully gripping an object (rather suitable for relatively large objects);

FIG. 7 is a schematic, side view of the device showing a mode of delicately gripping the object (rather suitable for relatively small objects);

FIG. 8 is a schematic, perspective view of a finger according to a variant of an embodiment;

FIG. 9 is a schematic, perspective view of a gripping device according to a second embodiment;

FIG. 10 is a view similar to FIG. 9 of a first variant of the second embodiment;

FIG. 11 is a view similar to FIG. 9 of a second variant of the second embodiment;

FIG. 12 is a schematic, perspective view of a gripping device according to a third embodiment;

FIG. 13 is a schematic view illustrating, in a simplified manner, the mechanism of one of the fingers of the device;

FIG. 14 is a schematic, cross-sectional view of the upper part of one of the fingers according to the invention;

FIG. 15 is a view similar to FIG. 6 of a device according to a fourth embodiment;

FIG. 16 is a schematic, top, cross-sectional view illustrating, in a simplified manner, the gripping of a cylindrical object by a device according to the invention;

FIG. 17 is a schematic, top, cross-sectional view illustrating, in a simplified manner, the gripping of a spherical object by a device according to the invention;

FIG. 18 is a schematic, top, cross-sectional view illustrating, in a simplified manner, the gripping of a parallelepiped object by a device according to the invention;

FIG. 19 is a schematic, partially perspective view of a finger according to a variant of an embodiment of the invention;

FIG. 20 is a schematic, partially perspective view of a finger according to a variant of an embodiment of the invention.

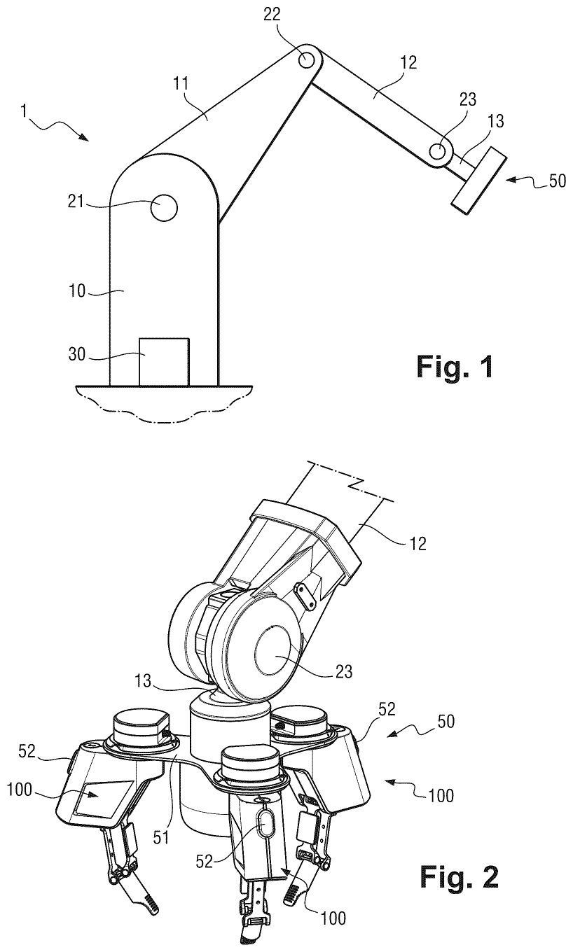

### DETAILED DESCRIPTION OF THE INVENTION

In reference to the figures, the invention is described, in this case, in application to a robotic arm generally referenced as 1.

The robotic arm 1 comprises a base 10, a first segment 11 connected to the base 10 by a first articulation 21, a second segment 12 connected to the first segment 11 by a second articulation 22, and an interface 13 which is connected to the second segment 12 by a third articulation 23 and which carries a gripping device generally referenced as 50 forming the free end of the robotic arm.

The robotic arm comprises actuators, in this case, such as motors, to move the elements connected to one same articulation 21, 22, 23 against one another. These actuators are not represented, in this case.

In a manner known in itself, each articulation 21, 22, 23 comprises a coder, not represented, arranged to measure the angle formed by the two elements connected by said articulation 21, 22, 23.

The motors and the coders are connected to a general control unit. In the present case, the general control unit is a general electronic control unit called electronic control unit 30 below. Said unit comprises at least one processor and a memory containing a program executed by said processor to control the motors according to the instructions of the program, measurements provided by the coders and other sensors like current sensors in the motors making it possible to determine a force developed by each of the motors. The electronic control unit 30 is preferably connected to an electronic signal emitter/receiver, for example according to the standard called BLUETOOTH.

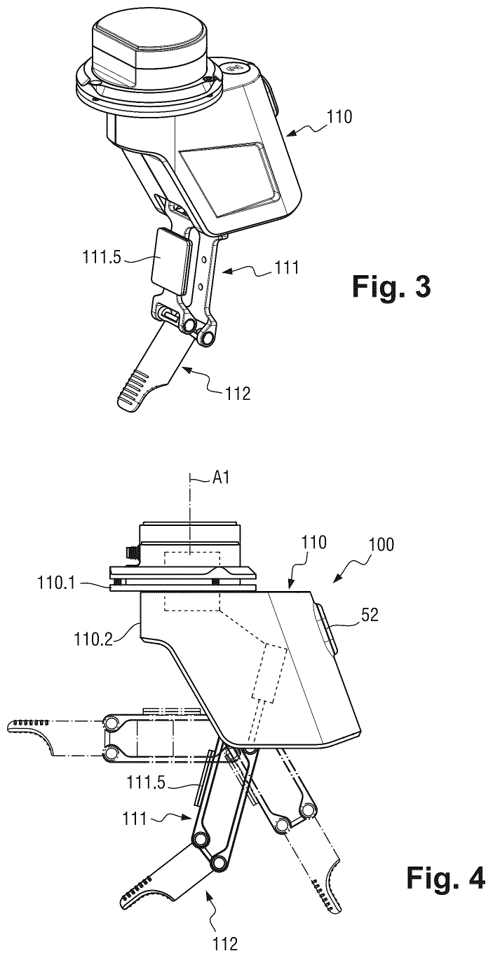

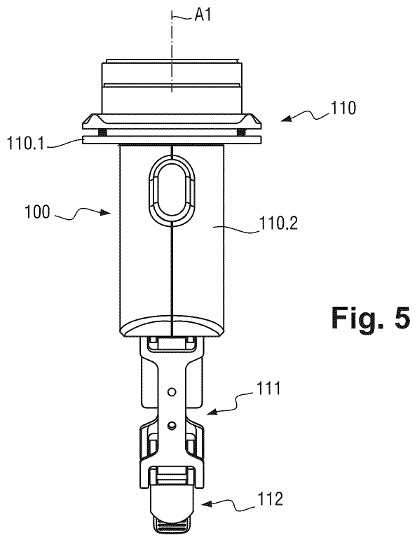

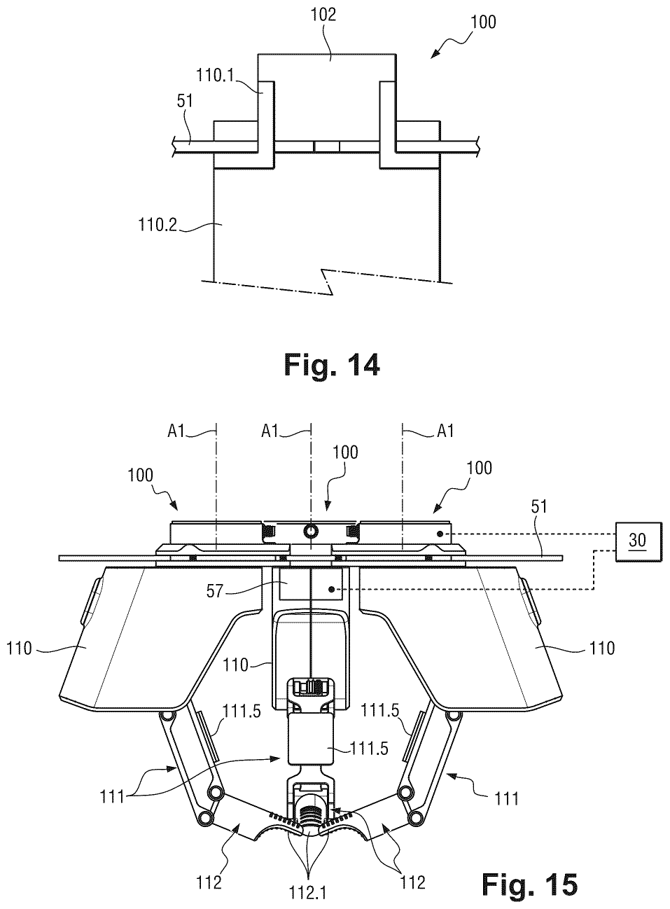

In reference to FIGS. 2 to 7, 13 and 14, and according to the first embodiment, the gripping device 50 comprises a plate 51 for connecting to the interface 13 of the robotic arm 1. The plate 51 has the shape of a three-branch plate extending symmetrically with respect to a central portion secured to the interface 13.

Each branch of the plate 51 is provided with a hole enabling the fastening of a finger generally referenced as 100.

Each finger 100 comprises a base 110 for fastening to the plate 51, a first phalanx 111 connected to the base 110 by at least one first articulation 121, a second phalanx 112 connected to the first phalanx 111 by at least one second articulation 122.

The first phalanx 111 has the shape of a deformable quadrilateral formed by a first side 111.1 opposite the base 110, a second side 111.2 which is opposite the first side 111.1 facing it and is connected by the first articulation 121 to the base 110, a third side 111.3 which is connected to the second side 111.2 by the first articulation 121 and to the first side 111.1 by the second articulation 122, and a fourth side 111.4 connected by a third articulation 123 to the second side 111.2 and by a fourth articulation 124 to the first side 111.1.

The second phalanx 112 is fastened onto the first side 111.1 of said quadrilateral. The third articulation 123 is free with respect to the base 110 and can therefore be moved in a circular arc around the first articulation 121. The second articulation 122 is free with respect to the base 110 and can be moved in n a circular arc around the first articulation 121. The third side 111.3, and therefore the first phalanx 111, can therefore pivot with respect to the base 110 between two end positions. The first side 111.1 can pivot around the second articulation 122: the second phalanx 112 can therefore pivot with respect to the first phalanx 111 between two end positions. The movement of the fourth articulation 124 is conditioned by the movements of the third articulation 123 and of the second articulation 122: the movement amplitude of the distal end of the second phalanx 112 (from one end position to another—see FIG. 4) with respect to the base 110 therefore depends on the combination of the movement of the first phalanx 111 with respect to the base 110 and of the movement of the second phalanx 112 with respect to the first phalanx 111.

The first phalanx 111 comprises a contact interface with the object to be gripped. The contact interface is, in this case, a support buffer 111.5 fastened onto the third side 111.3. The support buffer 111.5 is, for example, made of elastomer or of silicone.

The second phalanx 112 has a distal end portion 112.1 elastically deformable when bending. The distal end portion 112.1 is, for example, a metal strip covered with a flexible layer, for example made of elastomer or of silicone.

The finger 100 comprises a first actuator 101 which is fastened to the base 110 to move the third articulation 123 in a circular arc around the second articulation 122. The actuator 101 is, in this case, an electric actuator. The first actuator 101 is, in this case, a direct current rotary motor having an output shaft driving a screw/nut system (preferably, ball screw). The screw/nut system is, in this case, reversible, such that the force exerted by the finger 110 can be determined over its environment from a measurement of the supply current of the motor. The assembly formed of the actuator 101 and of the screw/nut system is thus an electromechanical, and more specifically, linear electromechanical actuation assembly.

If the actuator 101 pushes the third articulation 123 towards the third side 111.3, the third side 111.3 is made to pivot around the second articulation 122 until the third side 111.3 meets an obstacle. Once the third side 111.3 is abutted, if the movement of the third articulation 123 is continued, the pivoting of the first side 111.1 around the second articulation 122 and therefore the movement of the second phalanx 112 is caused. The reverse movement makes it possible to return the first phalanx 111 and the second phalanx 112 into the initial position.

As the case may be, the actuator 101 can be controlled by position, by speed or by force. In the present embodiment, it is controlled by force. Preferably, if the shape and the mass of the objects to be gripped is always identical, the supply current of the motor will be monitored during gripping, in order to detect an operational anomaly or wear of the gripping device, and provide preventive maintenance operations.

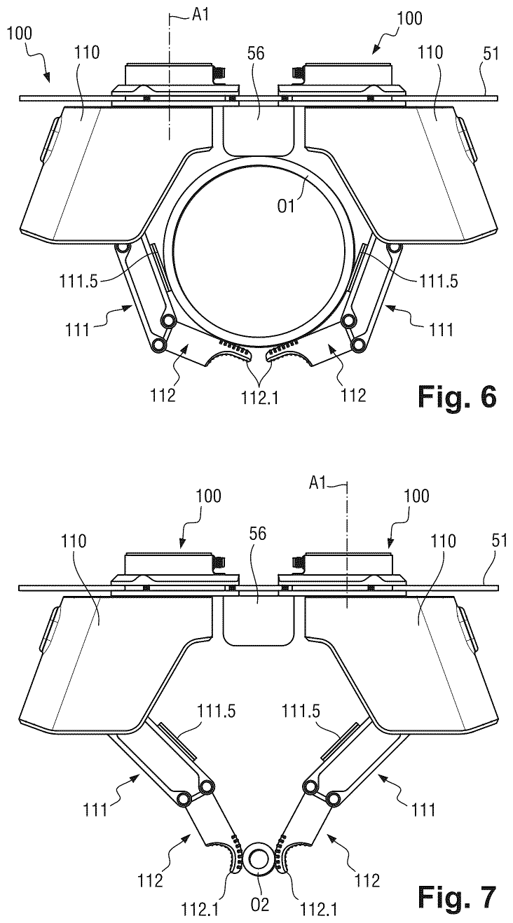

The powerful gripping of a tube with a relatively large diameter by two fingers 100 can be seen in FIG. 6. It is understood that the actuators 101 are controlled to close the fingers 100 on the tube. During the closure of the two fingers 100 on the tube, the first phalanxes 111 have pivoted towards the tube, the second phalanxes 112 remaining in the extension of the first phalanxes 111, until the support buffers 111.5 come into contact with the tube blocking the pivoting of the first phalanxes 111. The force of the actuator 101 being continued, the second phalanxes 112 pivot with respect to the first phalanxes until coming into contact with the tube. When the current measured at the motor of the actuator increases until reaching a threshold corresponding to the required gripping force. The fingers 110 are therefore in contact with the tube by the support buffers 111.5 and by the second phalanxes 112. It will be noted that this movement of the phalanxes makes it possible to limit the risk of an ejection of the object during the gripping.

The delicate gripping of a tube of relatively small diameter by the distal end portions 112.1 of two fingers can be seen in FIG. 7. It is understood that the actuators 101 are controlled to close the fingers 100 on the tube. During the closure of the two fingers 100 on the tube, the first phalanxes 111 have pivoted towards the tube, the second phalanxes 112 remaining in the extension of the first phalanxes 111, until that distal end portions 112.1 come into contact with the tube blocking the pivoting of the first phalanxes 111. With the force of the actuators 101 being continued, the distal end portions 112.1 are bent under the gripping force and the current measured at the motor of the actuator increases until reaching a threshold corresponding to the required gripping force. The fingers 110 are therefore in contact with the tube, only by the distal end portions 112.1 of the second phalanxes 112. It will be noted that each distal end portion 112.1 has a textured surface to improve the retention of the gripped object between the distal end portions 112.1

One single actuator therefore makes it possible to move the two phalanxes. Such a finger is called under-actuated, since it comprises less actuators than articulations.

Moreover, the base 110 comprises a fixed part 110.1 and a movable part 110.2 which carries the first motor and the phalanxes 111, 112 and which is connected to the fixed part 110.1 by a bearing defining an axis of orientation A1 and enabling a rotation of the movable part 110.2 with respect to the fixed part 110.1 about said axis of orientation A1. The base 110 comprises means for its fastening to the connecting plate, such that the axis of orientation A1 is substantially perpendicular to the plate 51. These fastening means can comprise screws screwed into the plate 51 by passing through lugs secured to the fixed part 110.1, bolts, flanges, locks, a bayonet connection, etc.

The finger 100 comprises a second actuator 102 mounted between the fixed part 110.1 and the movable part 110.2 of the base 110 to make the movable part 110.2 pivot and adjust the angular orientation of the movable part 110.2 with respect to the fixed part 110.1. The second actuator 102 is, for example, an electric actuator, such as an electric motor.

The two actuators 101, 102 are, in this case, connected to one same individual control unit secured to the base 110, and for example to its fixed part 110.1. In the present case, the individual control unit is an individual electronic control unit called electronic control unit 103 below. The electronic control unit 103 comprises, in this case, an ASIC circuit programmed to ensure a controlling of the actuators 101, 102 according to commands received by an electromagnetic signal emitter/receiver connected to the electronic control unit 103. These commands originate, for example, from the electronic control unit 30.

The base 110 is provided with a visual status indicator 52 (in this case, a light-emitting diode) and the electronic control unit 103 is connected to the indicator 52 to control said indicator 52 according to an operating status of the electronic control unit 103. Preferably, the indicator 52 can be controlled to light up in several colours according to the operating status (for example, green for a normal operation, yellow for an initialisation phase and red for a defect), continuously or discontinuously according to which the electronic control unit 103 executes a command or receives a command, or any other achievable code. In the case where the electronic control unit 103 is programmed by learning, it will advantageously be provided that the indicator 52 can signal to the operator, that the control unit 103 is in learning mode, for example, by flashing.

In dirty, aggressive (physico-chemical aggressions, more specifically), humid and/or sterile environments, a sealed fingerstall will advantageously be provided, having an opening enabling its threading on each finger, so as to cover each finger. The fingerstall can be made of any flexible material suitable for the considered use, and for example, made of silicone. The fastening of the fingerstall on the finger can be done, for example, by pinching or clamping, around the base of the finger, of the part of the fingerstall bordering its opening. The fingerstall can also only cover a part of the finger, for example, the second phalanx or the two phalanxes.

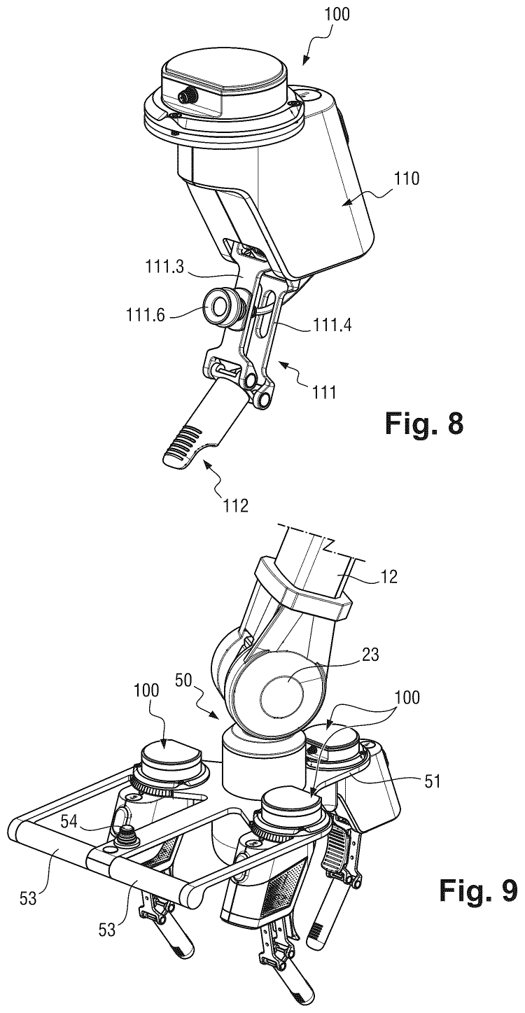

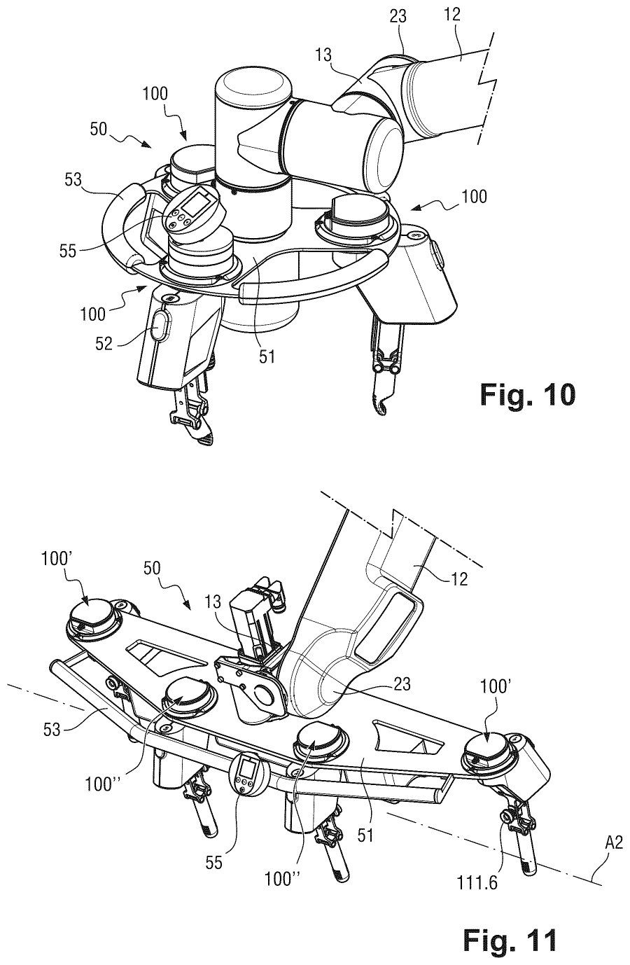

In the variant of an embodiment of FIG. 8, the support buffer 111.5 is replaced by a suction cup 111.6 connected by a fluid network to a vacuum generator.

According to the second embodiment represented in FIG. 9, the plate 51 has the shape of a plate as above, but is, in this case, provided with a handle 53 which can be gripped by an operator to direct the free end of the robotic arm 1 in the scope of a collaborative task, for example.

Commands can be sent to the electronic control unit 30 or to the electronic control unit 103 by at least one control button 54, which is mounted on the plate 51 in the proximity of the handle 53 and which is provided with an electromagnetic signal emitter connected to the emitter/receiver of the electronic control unit 103 and/or to that of the electronic control unit 30. The electronic control units are thus programmed to perform a collaborative task.

In a first variant of the second embodiment, variant represented in FIG. 11, the button 54 is replaced by a control interface 55 comprising a screen, a navigation button in a menu displayed on the screen, a button for selecting items from said menu, and one or more buttons directly controlling actions of the fingers 100 (for example, a button to grip and a button to release). The control interface comprises an electromagnetic signal emitter/receiver connected to the emitter/receiver of the electronic control unit 103 and/or to that of the electronic control unit 30.

As represented in FIG. 11 and according to a second variant of the second embodiment, the plate 51 has the shape of an elongated plate defining a longitudinal axis A2 and carrying two fingers 100′ at these two ends and two fingers 100″ in its median part. The two fingers 100″ are located on one same side of the axis A2 by being oriented towards the axis A2 and the two fingers 100′ are located on the side of the axis A2 opposite the fingers 100″ being themselves also oriented towards the axis A2. It is subsequently possible to grip an elongated object between the fingers 100′ on the one hand, and the fingers 100″ on the other hand.

As in the preceding variant, the plate 51 is provided with a handle 53 and a control interface 55.

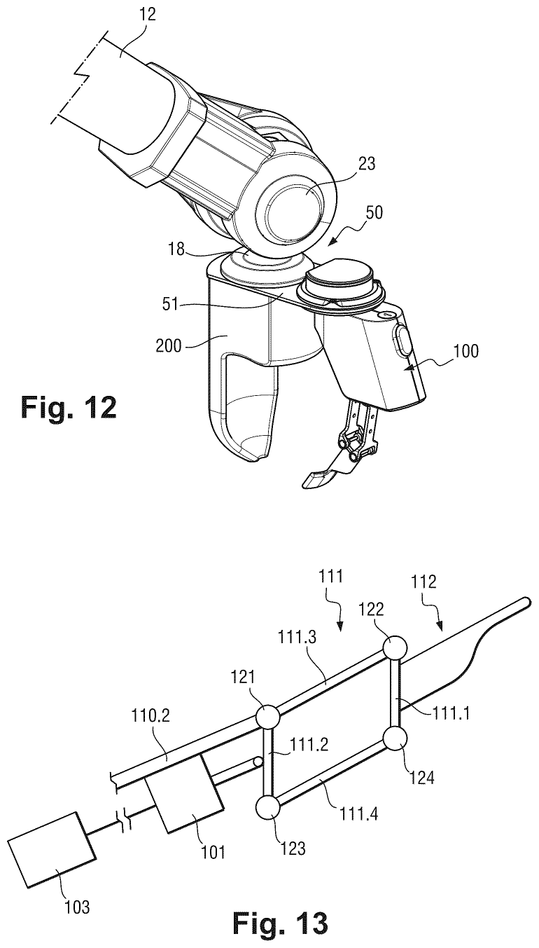

According to the third embodiment represented in FIG. 12, the gripping device can comprise at least one finger 100 and one abutment element 200 extending facing the finger 100. The abutment element can be a rigid or elastically deformable element, but sufficiently rigid to be able to oppose the movement of an object, which would be applied against the abutment element 200 by the finger 100 in question. The abutment element 200 can have a shape complementary to that of a part of the object to be gripped.

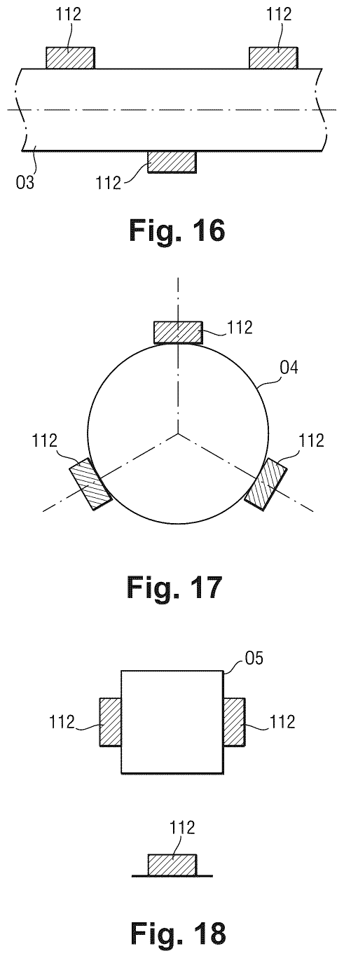

In the embodiment of FIG. 15, the device comprises a plate 51 provided with three fingers 100 each comprising a base with motorised orientation. A camera 57 is mounted under the plate 51, between the fingers 100, and is connected to the electronic control unit 30 to determine the shape of the object to be gripped and control the orientation of the fingers 100 in the configuration which is the most suitable for gripping the object. For example, the fingers can be controlled to perform an alternate gripping for an elongated or cylindrical object, as in FIG. 16, a spherical gripping for a ball-shaped object, as in FIG. 17, or a gripping with opposite fingers, in the case of a parallelepiped object, as in FIG. 18. The programming of the configurations can be done by coding, or by learning via an operator, who orients the fingers 100 in the correct orientation for each type of part, or the program for controlling the orientation of the fingers can involve a classification algorithm (neural network) enabling the program to determine, in real time, the configuration which is best suited to the shape of the object to be gripped, the shapes of the objects to be gripped and to deduce.

The invention, in this case, also relates to a kit for manufacturing a gripping device, comprising:
plates of different shapes (those represented in the figures),
fingers of different types (with fixed orientation and with manually or automatically adjustable orientation),
distal phalanxes of different shapes (as mentioned in the present description),
interfaces of different shapes (like those represented in the figures).

The kit also preferably comprises:
abutment elements of different shapes (as mentioned in the present description), and/or
fingerstalls for covering at least the distal phalanx of the fingers, and/or
proximity sensors (cameras, ultrasonic sensors), and/or
contact sensors, etc.

In this way, it is possible to manufacture, on demand, a gripping device which is suitable for the objects to be gripped. This is made possible by the modularity of the gripping device.

Naturally, the invention is not limited to the embodiment described, but comprises any variant entering into the field of the invention such as defined by the claims.

In particular, the fingers, the connecting plate and the robot arm can have structures different from those described.

The plate can have any shape which is suited to the gripping(s) to be performed and, for example, a shape with one or more branches, a circular, elliptic, rectangular, triangular or other shape.

The plate can also comprise two parts, the relative positions of which are adjustable, in a motorised manner or not, in order to adapt the configuration of the plate to the grippings to be performed.

The number of phalanxes, segments, articulations can be modified to adapt it to the movements to be performed. The articulations can be pivots or ball joints.

The finger can comprise at least one telescopic phalanx. The arm can comprise at least one telescopic segment.

The parts constituting each finger, the connecting plate and the arm can be produced by any method: cutting, stamping, forging, moulding, mechanical welding, additive manufacture, etc.

The parts constituting each finger, the connecting plate and the arm can be made of any material, the mechanical properties of which are compatible with the use considered, and for example, made of metal (steel, aluminium, titanium or other), made of thermoplastic material (polyamide, polyaramide, polypropylene, polyethylene, polyarcylobutadiene styrene, polycarbonate or other), optionally fibre-reinforced (glass, carbon, polyaramide or other), or other.

Any type of actuator (whether the first actuator or the second actuator is considered) can be used: electric and/or pneumatic and/or hydraulic. Any type of actuator (whether the first actuator or the second actuator is considered) can be used: linear or rotary, with or without reducer, linked or not to a movement transmission member such as, for example, a screw/nut system, such that the assembly formed by the actuator and the movement transmission member is linear or rotary, etc. It is possible to also use cable actuators, like cable jacks.

According to a variant with motorised orientation, it is possible to have one single actuator for the orientation of several fingers with respect to the plate.

According to a variant with manual orientation, the base can comprise an annular-shaped fixed part, wherein a part which is manually orientable with respect to the fixed part is pivotingly received. It is, for example, provided to be able to block the rotation of the movable part with respect to the fixed part by means of a needle screw engaged transversally in the fixed part to bear on the movable part, of a lock transversally movably mounted on the fixed part between a retracted position and a position projecting into a housing of a series of housings angularly distributed over a perimeter of the movable part, or other.

With the orientable fingers, it is possible to orient the fingers back-to-back to grip an object from the inside.

The base can be mounted on the plate to be fastened in orientation.

It is also possible to have, on one same plate, fingers of different types and, for example, a finger rotatably fixed about the axis A1, a finger which is manually orientable about the axis A1 and an axis with motorised orientation about the axis A1.

The contact interface of the first phalanx can have a structure different from those described or, on the contrary, have no contact interface.

The distal end portion of the second phalanx can have any shape which is suited to the gripping of the object to be gripped and, for example, a T-shape, a curved shape, or other. The distal end portion can comprise a contact interface like the first phalanx. Preferably, the distal end portion is removable to be able to be easily replaced when the objects to be gripped have shapes which can vary.

Contact sensors can be fastened onto the phalanxes, in order to be able to detect a sliding of the object.

Force sensors can also be added, for example, if at the output of the motor, a non-reversible movement transmission system is used. These force sensors are, for example, deformation gauges fastened onto the phalanxes or torque sensors disposed on the articulations. Using force sensors is advantageous when the object is fragile.

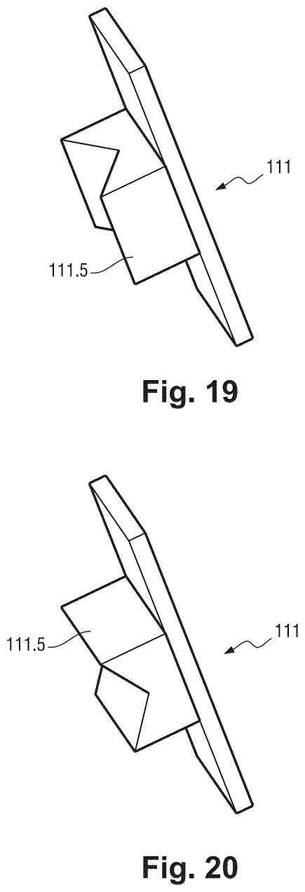

The support buffer can also have shapes favouring a blocking of the part, like for example a concave shape for centring the part (for example, forming a centring V, as represented in FIGS. 19 and 20, the V of FIG. 19 ensuring a centring in a vertical plane, the V of FIG. 20 ensuring a centring in a horizontal plane).

At least one position sensor can be mounted on the phalanxes, on the movement transmission system or on the actuator to enable a controlling of the actuator in position.

Each finger can comprise an electromagnetic brake to avoid the gripped object falling, in particular during the accomplishment of a collaborative task.

It is possible to equip the robotic arm with a sensor for sensing the presence of an operator in the environment of the arm, for example an ultrasonic sensor or a camera. This proximity sensor can serve both to detect the part to take and its shape to define the gripping or to detect the irruption of a human in the working space of the finger.

The gripping device can comprise an electronic control unit controlling the fingers and connected to the control unit of the robotic arm.

The individual control unit of one of the fingers can be programmed to form a master control unit, the individual control units of the other fingers being programmed to form slave control units; or the individual control units of all the fingers are programmed to form slave control units and the general control unit of the robot or of the gripping device is programmed to form a master control unit.

Wired connections can naturally be used instead of all or some of the wireless connections mentioned.

The individual control unit can be secured to the fixed and/or movable part of the base.

The motorised finger can comprise one same individual control unit controlling the first actuator and the second actuator of said finger or can comprise two different individual units, controlling each of the two actuators. In this case, at least one of the two individual control units can be secured to the fixed part of the base and/or movable from the base. At least one of the two individual control units can be at least partially an individual electronic control unit or can be exclusively an individual electronic control unit. According to the type of actuator considered, the individual control unit can be exclusively or partially electronic. For example, the individual control unit can be a least partially electric and/or hydraulic and/or pneumatic.

The invention can be used for any type of handling: rigid objects (for example, mechanical parts) or soft objects (for example, sachets containing liquids or powders), natural or industrial products, clean or dirty environment and/or transported product, etc.

1. A motorized finger, comprising a base for fastening to a plate for connecting to a robotic arm, a first phalanx connected to the base by at least one first articulation, a second phalanx connected to the first phalanx by at least one second articulation, a first actuator fastened to the base and connected at least to the first phalanx to move the phalanxes between two end positions, wherein the base comprises a fixed part and a movable part which carries the first actuator and the phalanxes and which is connected to the fixed part by a bearing defining an axis of orientation and enabling a rotation of the movable part with respect to the fixed part about said axis of orientation, in that the base comprises means for its fastening to the plate, such that the axis of orientation is substantially perpendicular to the plate, the motorised finger further comprising an individual control unit, secured to the base, which is connected to the first actuator to control it.

2. The motorized finger according to claim 1, wherein the first actuator is an electric and/or hydraulic and/or pneumatic actuator.

3. The motorized finger according to claim 1, wherein the first actuator is an electric actuator and the individual control unit is an individual electronic control unit.

4. The motorized finger according to claim 1, wherein the individual control unit is secured to the fixed part of the base.

5. The motorized finger according to claim 1, wherein the base comprises a second actuator arranged to make the movable part pivot and adjust the angular orientation of the movable part with respect to the fixed part.

6. The motorized finger (100) according to claim 5, wherein the individual control unit is also configured to control the second actuator.

7. The motorized finger according to claim 1, wherein the first phalanx has the shape of a deformable quadrilateral and the second phalanx is fastened onto a first side of said quadrilateral opposite the base, the quadrilateral comprising, opposite the first side, a second side which is connected by the first articulation to the base and to a third side and by a third articulation to a fourth side connected by a fourth articulation to the first side, the first actuator acting so as to move the third articulation with respect to the second articulation.

8. The motorized finger according to claim 1, wherein the first phalanx comprises a contact interface with the object to be gripped.

9. The motorized finger according to claim 8, wherein the contact interface is a support buffer.

10. The motorized finger according to claim 8, wherein the contact interface is a suction cup connected to a vacuum generator.

11. The motorized finger according to claim 1, wherein the control unit is arranged to ensure a controlling of the actuator in force return.

12. The motorized finger according to claim 1, wherein the control unit is connected to an electromagnetic signal emitter/receiver at least to receive commands.

13. The motorized finger according to claim 1, wherein the first actuator is reversible such that the force exerted by the finger on its environment can be determined from a measurement of the supply current of the first actuator.

14. The motorized finger according to claim 1, wherein a visual status indicator is carried by the base and the control unit is connected to the indicator to control said indicator according to an operating status of the control unit.

15. The motorized finger according to claim 1, wherein the second phalanx has a distal end portion elastically deformable when bending.

16. A gripping device, comprising a plate for connecting to a robot arm, on which are mounted at least one first motorized finger according to claim 1, having its base received in a hole of the plate, and at least one abutment element extending facing the motorized finger.

17. The gripping device according to claim 16, wherein the abutment element is a second motorized finger.

18. The gripping device according to claim 16, wherein each motorized finger comprises an individual control unit in communication with a master control unit.

19. The gripping device according to claim 16, wherein each motorized_finger comprises an individual control unit and one of the individual control units is programmed to form a master control unit, the other individual control units being programmed to form slave control units.

20. The gripping device_according to claim 16, comprising a general control unit in communication with at least one sensor of the external environment of the gripping device.

21. A robotic arm comprising a base, a first segment connected to the base by a first articulation, a second segment connected to the first segment by a second articulation, and an interface which is connected to the second segment by a third articulation and which carries a connecting plate of a gripping device according to claim 16.

22. A robotic arm according to claim 21, further comprising a general control unit programmed to control the arm during a collaborative task with an operator, the connecting plate comprising a handle which can be gripped by the operator to guide the robot.

23. A kit for manufacturing a gripping device, comprising plates of different shapes, the motorized fingers according to claim 1, distal phalanxes of different shapes, interfaces of different shapes.

24. The kit according to claim 23, further comprising abutment elements of different shapes.

25. The kit according to claim 23, further comprising fingerstalls to cover at least the distal phalanx of the motorized fingers.
